(19) United States
(12) Patent Application Publication
(10) Pub. No.: US 2016/0291327 A1
(43) Pub. Date: Oct. 6, 2016

(54) GLASS-TYPE IMAGE DISPLAY DEVICE AND METHOD FOR CONTROLLING SAME

(71) Applicant: LG ELECTRONICS INC., Seoul (KR)

(72) Inventors: Hyungjoon KIM, Seoul (KR); Taegil CHO, Seoul (KR); Yongki YOON, Seoul (KR)

(21) Appl. No.: 15/026,934

(22) PCT Filed: Apr. 7, 2014
(86) PCT No.: PCT/KR2014/002953

§ 371 Date: Apr. 1, 2016

(30) Foreign Application Priority Data
Oct. 8, 2013 (KR) 10-2013-0119998

(51) Int. Cl. G02B 27/01; G06F 3/01; G06F 3/16

(52) U.S. Cl. CPC G02B 27/0172; G06F 3/167; G02B 27/0176; G06F 3/017; G02B 2027/0178; G02B 2027/0138; G02B 2027/0154; G02B 2027/0161; G02B 2027/0118

(57) ABSTRACT

The present invention relates to a glass-type image display device such as a head-mounted display (HMD) formed so as to be worn on a part of the human body, and a method for controlling the same. The glass-type image display device comprises: a main body formed so as to be worn on a head of a user; a position detecting unit formed at the main body and detecting a position on which the main body is worn; an output unit formed in the main body and having an image output unit which outputs image information and an audio output unit which outputs audio information when operated; and a control unit for determining whether to operate the image output unit and/or the audio output unit according to the positions at which the main body is worn that have been detected by the position detecting unit.

### TECHNICAL FIELD

The present disclosure relates to an image display device, and more particularly, to a glass-type image display device such as a head mounted display formed to be worn on part of a human body and a control method thereof.

### BACKGROUND ART

An image display device may include both a device for recording and playing video back and a device for recording and playing audio back. The device for recording and playing video back as an image display device may include a TV set, a computer monitor, a projector and the like.

In recent years, a head mounted device (HMD) mounted on a user's head to display a stereoscopic screen in front of the user's eyes has been emerged as a new image display device, and improved as a glass-type image display device to be convenient to wear.

As it becomes multifunctional, such a glass-type image display device may be implemented as a multimedia player provided with complicated functions such as capturing photos or videos, playing games, receiving broadcasts in addition to a function of playing music or video files back. Moreover, in order to support and enhance the foregoing functions of the glass-type image display device, the improvement of structural or software elements of the glass-type image display device may be taken into consideration.

On the other hand, the background technologies of the present disclosure is disclosed in the Korean Patent Publication No. 10-2001-0047747.

### DISCLOSURE OF INVENTION

### Technical Problem

An aspect of the present disclosure is to provide a glass-type image display device that is convenient to wear and configured to execute a different operation mode according to the purpose of use, and a control method thereof.

Another aspect of the present disclosure is to provide a glass-type image display device capable of displaying image information in any one method of virtual image optics and projection image optics, and a control method thereof.

Still another aspect of the present disclosure is to provide a glass-type image display device for entering a control command with a different method from the related art, and a control method thereof.

### Solution to Problem

In order to accomplish an object of the present disclosure, a glass-type image display device according to an embodiment of the present disclosure may include a body formed to be worn on a user's head, a location sensing unit formed on the body to sense a location on which the body is worn, an output unit formed on the body, and provided with an image output unit configured to display image information and a voice output unit configured to output voice information when operated, and a controller configured to determine at least one operation of the image output unit and the voice output unit according to the wearing location of the body sensed by the location sensing unit.

According to an embodiment, the controller may execute either one of a first and a second operation mode according to the wearing location of the body, and operate the image and voice output unit in the first operation mode, and operate the voice output unit in the second operation mode.

According to an embodiment, the image output unit may be rotatably coupled to the body in a first state disposed to cover a front side portion of the body and a second state disposed in parallel to the front side portion.

According to an embodiment, the image output unit may be configured to display an image having a different focal length in the first state and the second state.

According to an embodiment, the image output unit may be configured to display an image toward the eyes of a user wearing the body in the first state.

According to an embodiment, the image output unit may be configured to display an image toward a screen disposed to be separated in the second state to project an image on the screen.

According to an embodiment, the glass-type image display device may further include a distance measurement unit formed adjacent to the image output unit in the body, and configured to measure a distance between the screen and the image output unit, wherein the controller is configured to adjust a focal length of an image displayed on the image output unit based on a distance measured by the distance measurement unit.

According to an embodiment, the controller may be configured to display guide information for guiding the location of the body to move using the output unit when the distance measured by the distance measurement unit does not satisfy a predetermined condition.

According to an embodiment, the image output unit may include a first and a second image output unit, and configured to display a two-dimensional or three-dimensional image on the screen using at least one of the first and the second image output unit.

According to an embodiment, the glass-type image display device may further include a status sensing unit configured to sense whether the image output unit is placed in the first state or the second state.

According to an embodiment, the status sensing unit may be installed on a hinge rotatably coupled to the body.

According to an embodiment, the glass-type image display device may further include a luminance sensing unit configured to sense ambient brightness on the body, wherein the controller adjusts the brightness of an image displayed on the image output unit based on an ambient luminance value acquired by the luminance sensing unit.

According to an embodiment, the glass-type image display device may further include a wireless communication unit configured to search an external device located within a predetermined distance, and perform communication with the searched external device, wherein the controller transmits at least one of image information displayed on the image output unit and voice information outputted from the voice output unit to be outputted on the external device.

According to an embodiment, the image output unit may display a control image allocated to at least one control command, and further include a gesture sensing unit configured to sense a gesture applied to a space defined to correspond to the control image, wherein the controller executes a function associated with a control command allocated to the control command based on a gestured sensed on the gesture sensing unit.

According to an embodiment, the control image may include a plurality of images associated with different control commands, respectively.

A space defined to corresponds to the control image may be divided into a plural number to allow one of the plurality of images to be disposed in each space, and a different control command to be allocated to each image.

According to an embodiment, a space defined to corresponds to the control image may be a virtual space recognized beyond the image output unit on a user's line of sight, and the controller may give perspective to the control image to recognize the control image to be displayed on the virtual space.

Furthermore, in order to implement the foregoing tasks, there is disclosed a control method of a glass-type image display device. A control method of a glass-type image display device, as a control method of a glass-type image display device having a body formed to be worn on a user's head, may include sensing a location on which the body is worn using a location sensing unit, and executing either one of a first and a second operation mode according to the wearing location of the body sensed by the location sensing unit, and operating an image output unit and a voice output unit in the first operation mode to output an image and a voice, and operating the voice output unit in the second operation mode to output a voice.

According to an embodiment, the image output unit may be rotatably coupled to the body in a first state disposed to cover a front side portion of the body and a second state disposed in parallel to the front side portion, and configured to display an image having a different focal length in the first state and the second state.

According to an embodiment, the control method of a glass-type image display device may further include displaying a control image on the image output unit in response to a touch input applied to the body, sensing a gesture applied to a space defined to correspond to the control image, and executing a function associated with a control command allocated to the control image based on the sensed gesture.

### Advantageous Effects of Invention

A glass-type image display device according to an embodiment of the present disclosure may execute a different operation mode according to the wearing location thereof, thus allowing a user to use the glass-type image display device in various ways. As a result, it may be possible to enhance user convenience.

In addition, a glass-type image display device according to an embodiment of the present disclosure may rotate from a first state in which the image output unit is disposed to cover a front side portion of the body to a second state in which the image output unit is disposed in parallel to the front side portion. It may be possible to display an image onto a user's both eyes like a head mounted display in the first state, and display an image onto a screen like a projector in the second state. As a result, a personally used device may be also used as a device capable of allowing several persons to view an image at the same time.

In addition, an glass-type image display device according to an embodiment of the present disclosure may allow a user to enter a control command to the glass-type image display device through a gesture applied to a space defined to correspond to a control image, thereby overcoming the difficulties of an input method in the related art in which the glass-type image display device should be continuously touched.

### BRIEF DESCRIPTION OF DRAWINGS

FIG. 1 is a block diagram illustrating a glass-type image display device associated with an embodiment of the present disclosure;

FIG. 2 is a perspective view illustrating an example of a glass-type image display device associated with the present disclosure;

FIG. 3 is an exemplary view for explaining a method of wearing a glass-type image display device according to an embodiment of the present disclosure;

FIG. 4 is a flow chart for explaining a method of controlling a glass-type image display device according to an embodiment of the present disclosure;

FIGS. 5A and 5B are conceptual views for explaining a control method illustrated in FIG. 4;

FIG. 6 is a conceptual view for explaining an embodiment in which an image output unit rotates on a glass-type image display device according to an embodiment of the present disclosure;

FIGS. 7A and 7B are conceptual views for explaining an embodiment in which a glass-type image display device according to an embodiment of the present disclosure is used as a projector;

FIGS. 8A and 8B are conceptual views for explaining an embodiment in which a glass-type image display device according to an embodiment of the present disclosure interacts with an external device;

FIG. 9 is a flow chart for explaining a control method of entering a control command in a different method from the related art in a glass-type image display device according to an embodiment of the present disclosure; and

FIGS. 10A, 10B and 10C are conceptual views for explaining a control method illustrated in FIG. 9.

### MODE FOR INVENTION

Hereinafter, preferred embodiments of the present invention will be described in detail with reference to the accompanying drawings, and the same or similar elements are designated with the same numeral references regardless of the numerals in the drawings and their redundant description will be omitted. A suffix “module” or “unit” used for constituent elements disclosed in the following description is merely intended for easy description of the specification, and the suffix itself does not give any special meaning or function. In describing the present invention, moreover, the detailed description will be omitted when a specific description for publicly known technologies to which the invention pertains is judged to obscure the gist of the present invention.

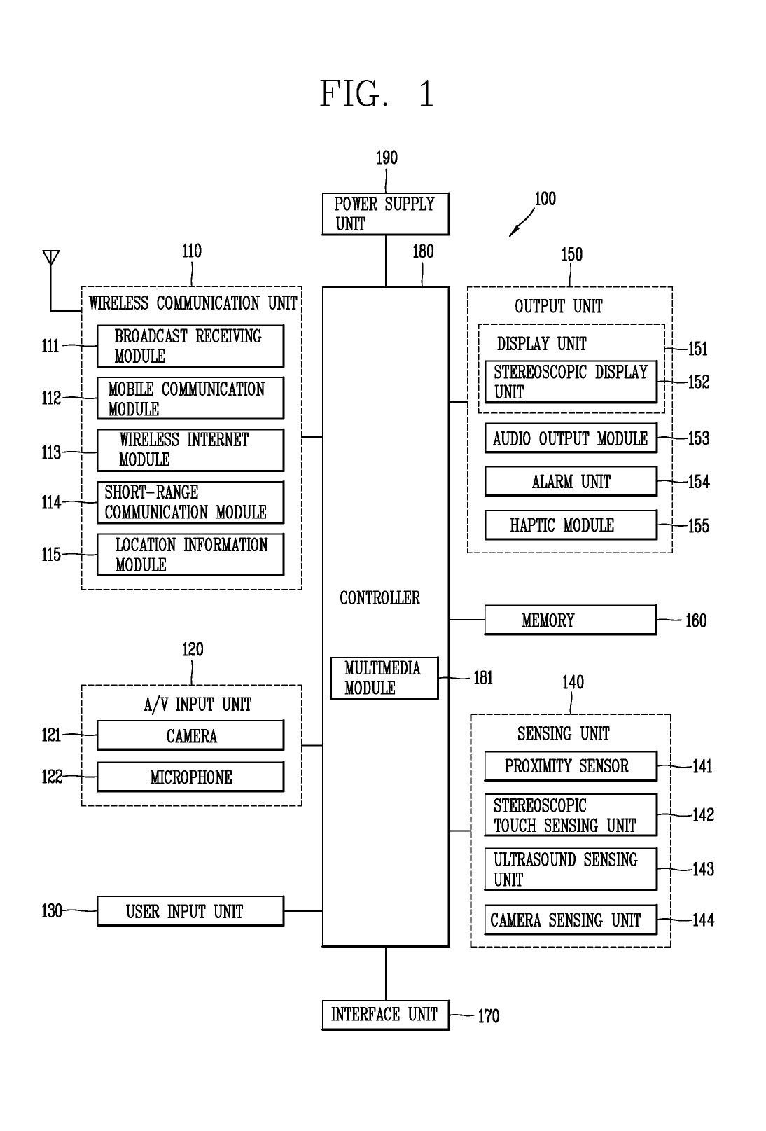

FIG. 1 is a block diagram illustrating a glass-type image display device 100 associated with an embodiment disclosed in the present disclosure.

The glass-type image display device 100 may include a wireless communication unit 110, an audio/video (AN) input unit 120, a user input unit 130, a sensing unit 140, an output unit 150, a memory 160, an interface unit 170, a controller 180, a power supply unit 190, and the like. However, the constituent elements as illustrated in FIG. 1 are not necessarily required, and the mobile communication terminal may be implemented with greater or less number of elements than those illustrated elements.

Hereinafter, the foregoing constituent elements will be described in sequence.

The wireless communication unit 110 may include one or more modules allowing radio communication between the glass-type image display device 100 and a wireless communication system, or allowing radio communication between the glass-type image display device 100 and a network in which the glass-type image display device 100 is located. For example, the wireless communication unit 110 may include at least one of a broadcast receiving module 111, a mobile communication module 112, a wireless Internet module 113, a short-range communication module 114, a location information module 115, and the like.

The broadcast receiving module 111 receives a broadcast signal and/or broadcast associated information from an external broadcast managing entity via a broadcast channel.

The broadcast channel may include a satellite channel and a terrestrial channel. The broadcast managing entity may indicate a server which generates and transmits a broadcast signal and/or broadcast associated information or a server which receives a pre-generated broadcast signal and/or broadcast associated information and sends them to the terminal. The broadcast signal may be implemented as a TV broadcast signal, a radio broadcast signal, and a data broadcast signal, among others. The broadcast signal may further include a data broadcast signal combined with a TV or radio broadcast signal.

Examples of broadcast associated information may include information associated with a broadcast channel, a broadcast program, a broadcast service provider, and the like. The broadcast associated information may be provided via a mobile communication network, and received by the mobile communication module 112.

The broadcast associated information may be implemented in various formats. For instance, broadcast associated information may include Electronic Program Guide (EPG) of Digital Multimedia Broadcasting (DMB), Electronic Service Guide (ESG) of Digital Video Broadcast-Handheld (DVB-H), and the like.

The broadcast receiving module 111 may be configured to receive digital broadcast signals transmitted from various types of broadcast systems. Such broadcast systems may include Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Integrated Services Digital Broadcast-Terrestrial (ISDB-T) and the like. Of course, the broadcast receiving module 111 may be configured to be suitable for every broadcast system transmitting broadcast signals as well as the digital broadcasting systems.

Broadcast signals and/or broadcast associated information received via the broadcast receiving module 111 may be stored in a memory 160.

The mobile communication module 112 transmits and receives wireless signals to and from at least one a base station, an external terminal and a server on a mobile communication network. Here, the wireless signals may include audio call signals, video call signals, or various formats of data according to the transmission and reception of text/multimedia messages.

The mobile communication module 112 may be configured to implement an video communication mode and a voice communication mode. The video communication mode refers to a configuration in which communication is made while viewing the image of the counterpart, and the voice communication mode refers to a configuration in which communication is made without viewing the image of the counterpart. The mobile communication module 112 may be configured to transmit or receive at least one of audio or video data to implement the video communication mode and voice communication mode.

The wireless Internet module 113 refers to a module for supporting wireless Internet access, and may be built-in or externally installed on the glass-type image display device 100. Here, it may be used a wireless Internet access technique including WLAN (Wireless LAN), Wi-Fi (Wireless Fidelity) Direct, DLNA (Digital Living Network Alliance), Wibro (Wireless Broadband), Wimax (World Interoperability for Microwave Access), HSDPA (High Speed Downlink Packet Access), and the like.

The short-range communication module 114 refers to a module for supporting a short-range communication. Here, it may be used a short-range communication technology including Bluetooth™, Radio Frequency IDentification (RFID), Infrared Data Association (IrDA), Ultra WideBand (UWB), ZigBee, Near Field Communication (NFC) and the like.

The location information module 115 is a module for checking or acquiring the location of the glass-type image display device, and there is a Global Positioning Module (GPS) module or Wireless Fidelity (WiFI) as a representative example.

Referring to FIG. 1, the A/V(audio/video) input unit 120 receives an audio or video signal, and the A/V (audio/video) input unit 120 may include a camera 121 and a microphone 122. The camera 121 processes image frames, such as still or moving images, obtained by an image sensor in a video phone call or image capturing mode. The processed image frame may be displayed on an image output unit 151.

The image frames processed by the camera 121 may be stored in the memory 160 or transmitted to an external device through the wireless communication unit 110. Furthermore, the user's location information or the like may be produced from image frames acquired from the camera 121. Two or more cameras 121 may be provided according to the use environment.

The microphone 122 receives an external audio signal through a microphone in a phone call mode, a recording mode, a voice recognition mode, and the like, and processes the audio signal into electrical voice data. The processed voice data may be converted and outputted into a format that is transmittable to a mobile communication base station through the mobile communication module 112 in the phone call mode. The microphone 122 may implement various types of noise canceling algorithms to cancel noise generated in a procedure of receiving the external audio signal.

The user input unit 130 may generate input data to control an operation of the terminal. The user input unit 130 may be configured by including a keypad, a dome switch, a touch pad (pressure/capacitance), a jog wheel, a jog switch, and the like.

The sensing unit 140 detects a current status of the glass-type image display device 100 such as a location of the glass-type image display device 100, a presence or absence of user contact with the glass-type image display device 100, an orientation of the glass-type image display device 100, an acceleration/deceleration of the glass-type image display device 100, and the like, so as to generate a sensing signal for controlling the operation of the glass-type image display device 100. Furthermore, the sensing unit 140 may sense the presence or absence of power provided by the power supply unit 190, the presence or absence of a coupling between the interface unit 170 and an external device, and the like.

The output unit 150 is configured to generate an output associated with visual sense, auditory sense or tactile sense, and may include an image output unit 151, a voice output unit (or audio output module) 153, an alarm unit 154, a haptic module 155, and the like.

The image output unit 151 may display (output) information processed in the glass-type image display device 100. For example, when the glass-type image display device 100 is in a phone call mode, the image output unit 151 may display a User Interface (UI) or a Graphic User Interface (GUI) associated with a call. When the glass-type image display device 100 is in a video call mode or image capturing mode, the image output unit 151 may display a captured image and/or received image, a UI or GUI.

The image output unit 151 may include at least one of a Liquid Crystal Display (LCD), a Thin Film Transistor-LCD (TFT-LCD), an Organic Light Emitting Diode (OLED) display, a flexible display, a three-dimensional (3D) display, and an e-ink display.

Some of those displays may be configured with a transparent or optical transparent type to allow viewing of the exterior through the display unit, which may be called transparent displays. An example of the typical transparent displays may include a transparent LCD (TOLED), and the like. Under this configuration, a user can view an object positioned at a rear side of a mobile terminal body through a region occupied by the image output unit 151 of the mobile terminal body.

Two or more image output units 151 may be implemented according to a configured aspect of the glass-type image display device 100. For instance, a plurality of the image output units 151 may be arranged on one surface to be spaced apart from or integrated with each other, or may be arranged on different surfaces.

Furthermore, the image output unit 151 may be configured with a stereoscopic image output unit 152 for displaying a stereoscopic image.

Here, stereoscopic image indicates a 3-dimensional stereoscopic image, and the 3-dimensional stereoscopic image is an image for allowing the user to feel the gradual depth and reality of an object located on the monitor or screen as in a real space. The 3-dimensional stereoscopic image may be implemented by using binocular disparity. Here, binocular disparity denotes a disparity made by the location of two eyes separated from each other, allowing the user to feel the depth and reality of a stereoscopic image when two eyes see different two-dimensional images and then the images are transferred through the retina and merged in the brain as a single image.

A stereoscopic method (glasses method), an auto-stereoscopic method (no-glasses method), a projection method (holographic method), and the like may be applicable to the stereoscopic image output unit 152. The stereoscopic method primarily used in a home television receiver and the like may include a Wheatstone stereoscopic method and the like.

The examples of the auto-stereoscopic method may include a parallel barrier method, a lenticular method, an integral imaging method, and the like. The projection method may include a reflective holographic method, a transmissive holographic method, and the like.

In general, a 3-dimensional stereoscopic image may include a left image (image for the left eye) and a right image (image for the right eye). The method of implementing a 3-dimensional stereoscopic image can be divided into a top-down method in which a left image and a right image are disposed at the top and bottom within a frame, a left-to-right (L-to-R) or side by side method in which a left image and a right image are disposed at the left and right within a frame, a checker board method in which the pieces of a left image and a right image are disposed in a tile format, an interlaced method in which a left and a right image are alternately disposed for each column and row unit, and a time sequential or frame by frame method in which a left image and a right image are alternately displayed for each time frame, according to the method of combining a left image and a right image into a 3-dimensional stereoscopic image.

For 3-dimensional thumbnail images, a left image thumbnail and a right image thumbnail may be generated from the left and the right image of the original image frame, and then combined with each other to generate a 3-dimensional stereoscopic image. Typically, thumbnail denotes a reduced image or reduced still video. The left and right thumbnail image generated in this manner are displayed with a left and right distance difference on the screen in a depth corresponding to the disparity of the left and right image, thereby implementing a stereoscopic space feeling.

A left image and a right image required to implement a 3-dimensional stereoscopic image are displayed on the stereoscopic image output unit 152 by a stereoscopic processing unit (not shown). The stereoscopic processing unit receives a 3D image to extract a left image and a right image from the 3D image, or receives a 2D image to convert it into a left image and a right image.

On the other hand, when the image output unit 151 and a touch sensitive sensor (hereinafter, referred to as a “touch sensor”) have an interlayer structure (hereinafter, referred to as a “touch screen”), the image output unit 151 may be used as an input device in addition to an output device. The touch sensor may be implemented as a touch film, a touch sheet, a touch pad, and the like.

The touch sensor may be configured to convert changes of a pressure applied to a specific part of the image output unit 151, or a capacitance occurring from a specific part of the image output unit 151, into electric input signals. The touch sensor may be configured to sense not only a touched position and a touched area, but also a touch pressure at which a touch object body is touched on the touch sensor. Here, the touch object body may be a finger, a touch pen or stylus pen, a pointer, or the like as an object by which a touch is applied to the touch sensor.

When there is a touch input to the touch sensor, the corresponding signals are transmitted to a touch controller. The touch controller processes the signal(s), and then transmits the corresponding data to the controller 180. Accordingly, the controller 180 may sense which region of the image output unit 151 has been touched.

Referring to FIG. 1, a proximity sensor 141 may be arranged at an inner region of the glass-type image display device 100 surrounded by the touch screen, or adjacent to the touch screen. The proximity sensor 141 may be provided as an example of the sensing unit 140. The proximity sensor 141 refers to a sensor to sense the presence or absence of an object approaching to a surface to be sensed, or an object disposed adjacent to a surface to be sensed, by using an electromagnetic field or infrared rays without a mechanical contact. The proximity sensor 141 has a longer lifespan and a more enhanced utility than a contact sensor.

The proximity sensor 141 may include an optical transmission type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, the proximity of an object having conductivity (hereinafter, referred to as a “pointer”) to the touch screen is sensed by changes of an electromagnetic field. In this case, the touch screen (touch sensor) may be categorized into a proximity sensor.

Hereinafter, for the sake of convenience of brief explanation, a behavior that the pointer is positioned to be proximate onto the touch screen without contact will be referred to as a “proximity touch”, whereas a behavior that the pointer substantially comes in contact with the touch screen will be referred to as a “contact touch”. For the position corresponding to the proximity touch of the pointer on the touch screen, such position corresponds to a position where the pointer faces perpendicular to the touch screen upon the proximity touch of the pointer.

The proximity sensor 141 senses a proximity touch, and a proximity touch pattern (e.g., proximity touch distance, proximity touch direction, proximity touch speed, proximity touch time, proximity touch position, proximity touch moving status, etc.). Information relating to the sensed proximity touch and the sensed proximity touch patterns may be output onto the touch screen.

When the stereoscopic image output unit 152 and a touch sensor are configured with an interlayer structure (hereinafter, referred to as a “stereoscopic touch screen”) or the stereoscopic image output unit 152 and a 3D sensor for detecting a touch operation are combined with each other, the stereoscopic image output unit 152 may be used as a 3-dimensional input device.

As an example of the 3D sensor, the sensing unit 140 may include a proximity sensor 141, a stereoscopic touch sensing unit 142, a ultrasound sensing unit 143, and a camera sensing unit 144.

The proximity sensor 141 measures a distance between the sensing object (for example, the user's finger or stylus pen) and a detection surface to which a touch is applied using an electromagnetic field or infrared rays without a mechanical contact. The terminal may recognize which portion of a stereoscopic image has been touched by using the measured distance. In particular, when the touch screen is implemented with a capacitance type, it may be configured such that the proximity level of a sensing object is sensed by changes of an electromagnetic field according to the proximity of the sensing object to recognize a 3-dimensional touch using the proximity level.

The stereoscopic touch sensing unit 142 may be configured to sense the strength or duration time of a touch applied to the touch screen. For example, stereoscopic touch sensing unit 142 senses a user applied touch pressure, and if the applied pressure is strong, then the stereoscopic touch sensing unit 142 recognizes it as a touch for an object located farther from the touch screen.

The ultrasound sensing unit 143 may be configured to sense the location of the sensing object using ultrasound.

For example, the ultrasound sensing unit 143 may be configured with an optical sensor and a plurality of ultrasound sensors. The optical sensor may be formed to sense light, and the ultrasound sensor may be formed to sense ultrasound waves. Since light is far faster than ultrasound waves, the time for light to reach the optical sensor is far faster than the time for ultrasound waves to reach the ultrasound sensor. Accordingly, the location of the wave generating source may be calculated using a time difference between the light and ultrasound waves to reach the optical sensor.

The camera sensing unit 144 may include at least one of a camera 121, a photo sensor, and a laser sensor.

For example, the camera 121 and laser sensor may be combined to each other to sense a touch of the sensing object to a 3-dimensional stereoscopic image. Distance information sensed by the laser sensor is added to a two-dimensional image captured by the camera to acquire 3-dimensional information.

For another example, a photo sensor may be deposited on the display element. The photo sensor may be configured to scan the motion of the sensing object in proximity to the touch screen. More specifically, the photo sensor is integrated with photo diodes and transistors in the rows and columns thereof, and a content placed on the photo sensor may be scanned by using an electrical signal that is changed according to the amount of light applied to the photo diode. In other words, the photo sensor performs the coordinate calculation of the sensing object according to the changed amount of light, and the location coordinate of the sensing object may be detected through this.

The voice output unit 153 may output audio data received from the wireless communication unit 110 or stored in the memory 160, in a call-receiving mode, a call-placing mode, a recording mode, a voice recognition mode, a broadcast reception mode, and so on. The voice output unit 153 may output audio signals relating to the functions performed in the glass-type image display device 100 (e.g., sound alarming a call received or a message received, and so on). The voice output unit 153 may include a receiver, a speaker, a buzzer, and so on.

The alarm unit 154 outputs signals notifying occurrence of events from the glass-type image display device 100. The events occurring from the glass-type image display device 100 may include call received, message received, key signal input, touch input, and so on. The alarm unit 154 may output not only video or audio signals, but also other types of signals such as signals notifying occurrence of events in a vibration manner. Since the video or audio signals can be output through the image output unit 151 or the audio output unit 153, the image output unit 151 and the voice output unit 153 may be categorized into part of the alarm unit 154.

The haptic module 155 generates various tactile effects which a user can feel. A representative example of the tactile effects generated by the haptic module 154 includes vibration. Vibration generated by the haptic module 154 may have a controllable intensity, a controllable pattern, and so on. For instance, different vibration may be output in a synthesized manner or in a sequential manner.

The haptic module 155 may generate various tactile effects, including not only vibration, but also arrangement of pins vertically moving with respect to a skin being touched, air injection force or air suction force through an injection hole or a suction hole, touch by a skin surface, presence or absence of contact with an electrode, effects by stimulus such as an electrostatic force, reproduction of cold or hot feeling using a heat absorbing device or a heat emitting device, and the like.

The haptic module 155 may be configured to transmit tactile effects through a user's direct contact, or a user's muscular sense using a finger or a hand. The haptic module 155 may be implemented in two or more in number according to the configuration of the glass-type image display device 100.

The memory 160 may store a program for processing and controlling the controller 180. Alternatively, the memory 160 may temporarily store input/output data (e.g., phonebook, messages, still images, videos, and the like). Also, the memory 160 may store data related to various patterns of vibrations and sounds outputted upon the touch input on the touch screen.

The memory 160 may be implemented using any type of suitable storage medium including a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-only Memory (EEPROM), Programmable Read-only Memory (PROM), magnetic memory, magnetic disk, optical disk, and the like. Also, the glass-type image display device 100 may operate in association with a web storage which performs the storage function of the memory 160 on the Internet.

The interface unit 170 may generally be implemented to interface the glass-type image display device with external devices connected to the glass-type image display device 100. The interface unit 170 may allow a data reception from an external device, a power delivery to each component in the glass-type image display device 100, or a data transmission from the glass-type image display device 100 to an external device. The interface unit 170 may include, for example, wired/wireless headset ports, external charger ports, wired/wireless data ports, memory card ports, ports for coupling devices having an identification module, audio Input/Output (I/O) ports, video I/O ports, earphone ports, and the like.

On the other hand, the identification module may be configured as a chip for storing various information required to authenticate an authority to use the glass-type image display device 100, which may include a User Identity Module (UIM), a Subscriber Identity Module (SIM), and the like. Also, the device having the identification module (hereinafter, referred to as “identification device”) may be implemented in a type of smart card. Hence, the identification device can be coupled to the glass-type image display device 100 via a port.

Furthermore, the interface unit 170 may serve as a path for power to be supplied from an external cradle to the glass-type image display device 100 when the glass-type image display device 100 is connected to the external cradle or as a path for transferring various command signals inputted from the cradle by a user to the glass-type image display device 100. Such various command signals or power inputted from the cradle may operate as signals for recognizing that the glass-type image display device 100 has accurately been mounted to the cradle.

The controller 180 typically controls the overall operations of the glass-type image display device 100. For example, the controller 180 performs the control and processing associated with telephony calls, data communications, video calls, and the like. The controller 180 may include a multimedia module 181 which provides multimedia playback. The multimedia module 181 may be configured as part of the controller 180 or as a separate component.

Furthermore, the controller 180 can perform a pattern recognition processing so as to recognize writing or drawing input carried out on the touch screen as text or image.

Furthermore, the controller 180 may implement a lock state for limiting the user's control command input to applications when the state of the glass-type image display device satisfies a preset condition. Furthermore, the controller 180 may control a lock screen displayed in the lock state based on a touch input sensed through the image output unit 151 in the lock state.

The power supply unit 190 receives external and internal power to provide power required for various components under the control of the controller 180.

Various embodiments described herein may be implemented in a computer or similar device readable medium using software, hardware, or any combination thereof.

For hardware implementation, it may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units designed to perform the functions described herein. In some cases, such embodiments may be implemented in the controller 180 itself.

For software implementation, the embodiments such as procedures or functions described in the present disclosure may be implemented with separate software modules. Each of the software modules may perform at least one function or operation described in the present disclosure.

Software codes can be implemented by a software application written in any suitable programming language. The software codes may be stored in the memory 160 and executed by the controller 180.

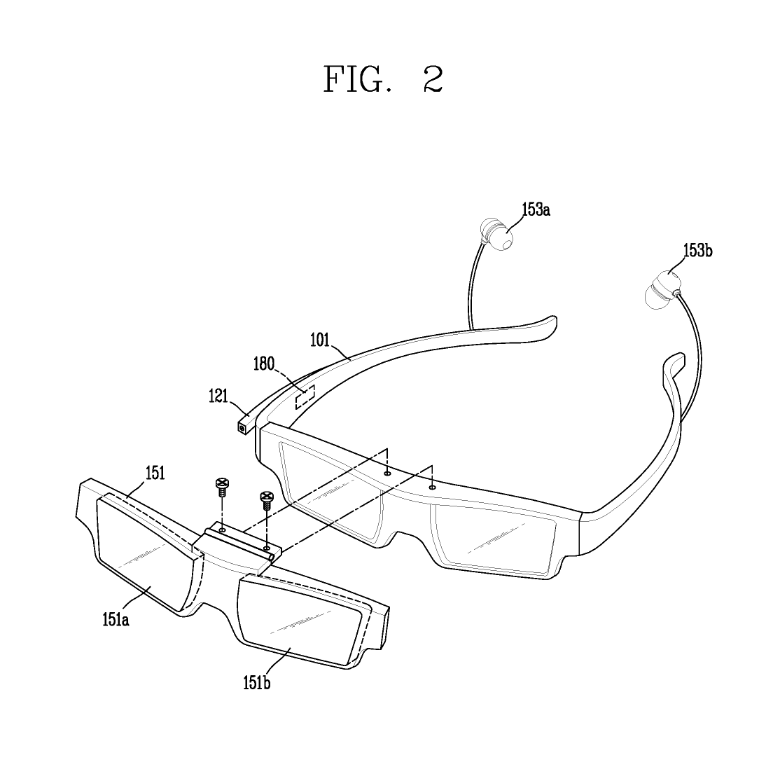

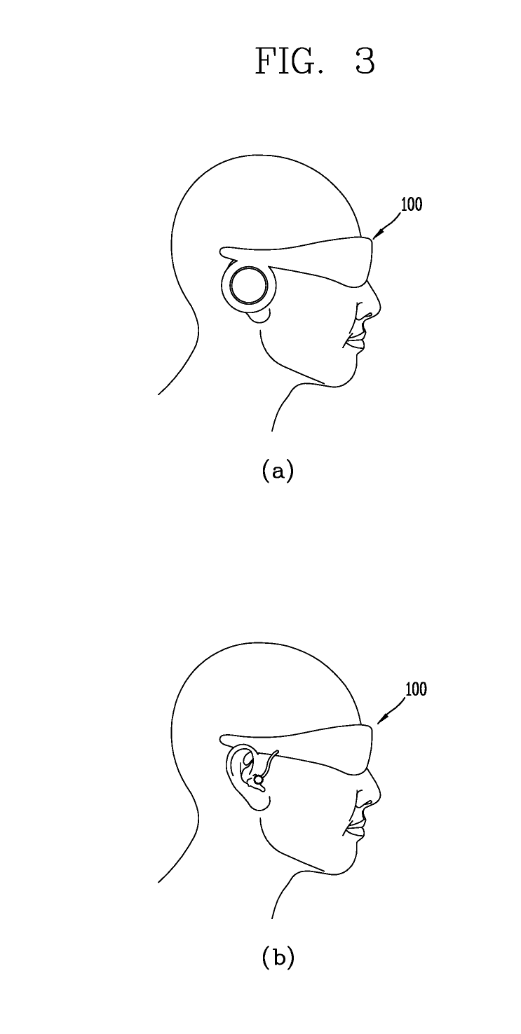

FIG. 2 is a perspective view illustrating an example of a glass-type image display device associated with the present disclosure, and FIG. 3 is an exemplary view for explaining a method of wearing a glass-type image display device according to an embodiment of the present disclosure.

Referring to FIG. 2, a glass-type image display device 100 according to an embodiment of the present disclosure may include a body 101 formed to be worn on a user's head, an image output unit 151, a camera 121, a controller and a voice output unit 153. In addition, the glass-type image display device 100 may further include at least one of the foregoing constituent elements.

Referring to FIG. 2, a glass-type image display device 100 according to an embodiment of the present disclosure may be formed in a glasses type, but the present disclosure may not be necessarily limited to this, and may be also implemented in various forms such as a hair band, a helmet, smart glasses, or the like.

The body 101 is formed to be worn on a head. For example, it may be implemented with a glasses shaped frame and a leg portion.

On the other hand, a light shielding film may be formed in a region adjacent to the leg portion of the body 101 and the image output unit 151. It is to prevent an image displayed on the image output unit 151 from being interfered with another ambient light source.

On the other hand, the image output unit 151 is formed in a rectangular box shape, and disposed to cover at least part of a front side portion of the body 101. Here, the image output unit 151 may be coupled to the body 101 by a fastening portion 200. The fastening portion 200 is formed to allow the image output unit 151 to be rotatably coupled to the body, and the image output unit 151 disposed to cover a front side portion of the body 101 by the fastening portion 200 may rotate to be disposed in parallel to the front side portion. For example, the fastening portion 200 may be a hinge. The characteristics associated with the rotation of the image output unit 151 will be described below with reference to FIG. 6.

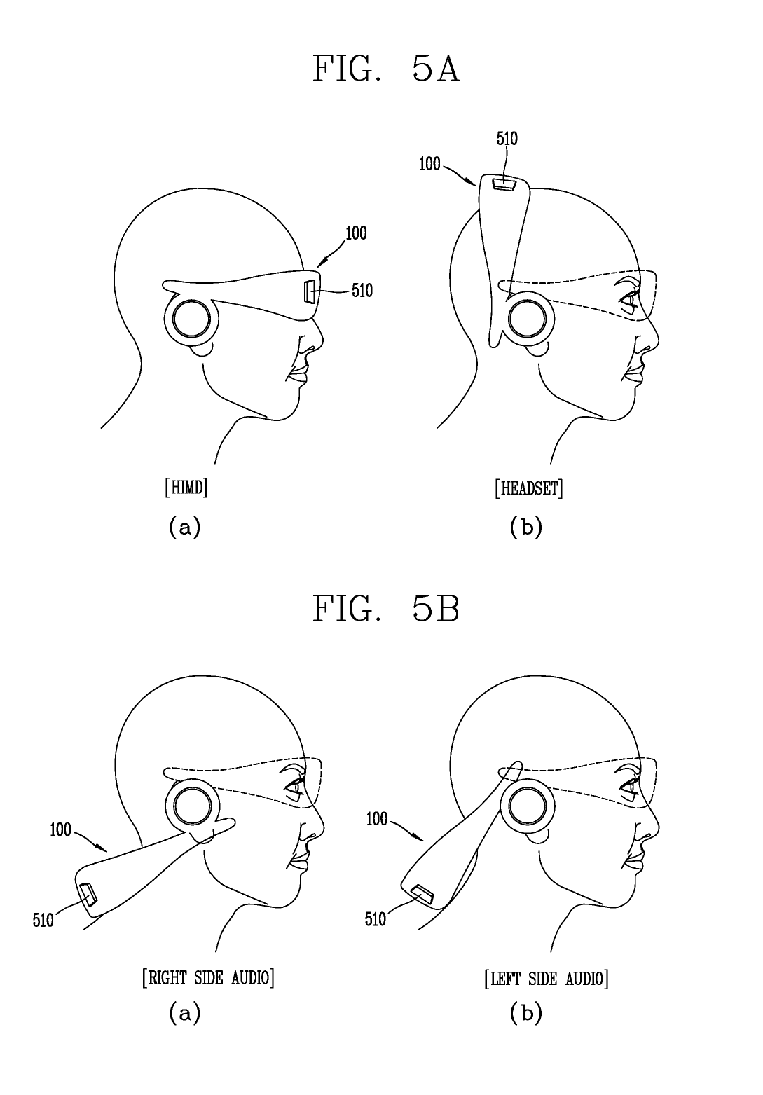

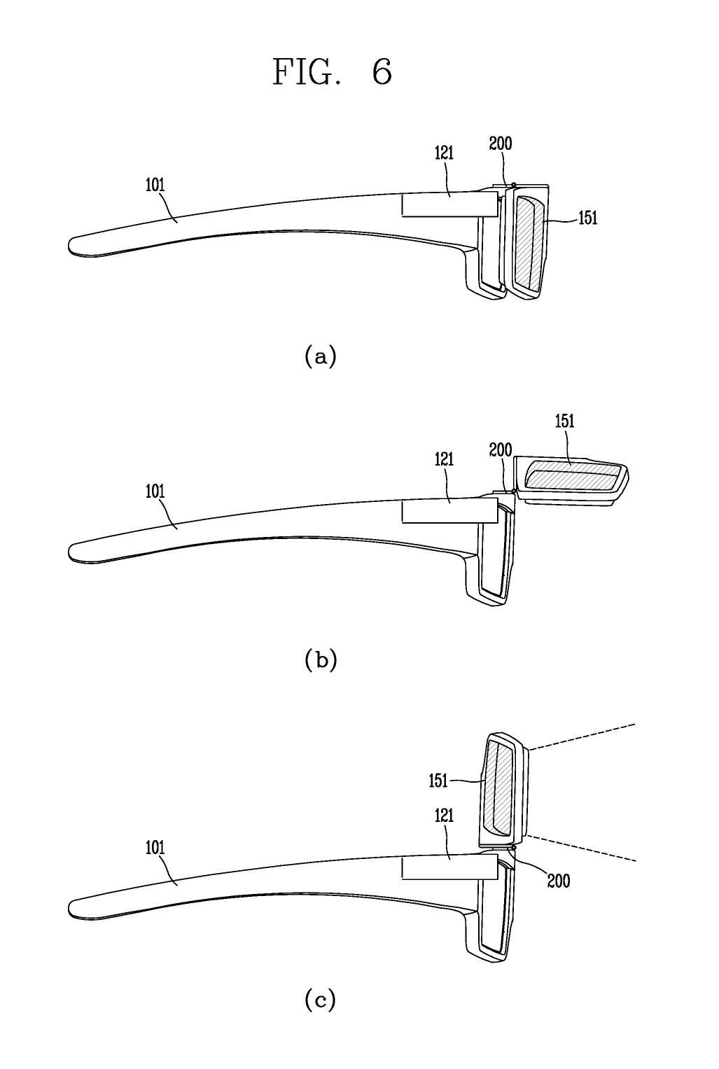

Referring to FIG. 5 again, the image output unit 151 may include a first and a second image output unit 151a, 151b. The first and the second image output unit 15a, 151b may be disposed at the locations of both eyes of a user, and may display a 3D image by different image output units. Contrary to the illustration of the drawing, the image output unit may be formed in a single unit, and may also be modified in various forms according to the embodiment.

On the other hand, since a distance between the eyebrows may vary according to users, and the locations of the first and the second image output unit 15a, 151b may be changed by the user's manipulation.

On the other hand, the image output unit 151 may display image information (or visual information). To this end, though not shown in the drawing, an inside of the image output unit 151 may include a light source, and an image formation unit, for instance, a liquid crystal panel, configured to generate image information in response to a light beam generated from the light source, and a plurality of lenses, reflectors and optical elements configured to control a light beam irradiated from the light source to an image generation unit and form a light path to irradiate the image information to the user's both eyes.

An ocular lens capable of allowing a user to directly view an image with his or her eyes may be formed on the image output unit 151, and due to this, the image output unit 151 may display an image in response to an input signal.

On the other hand, image information displayed on the image output unit 151 may denote an image generated from the glass-type image display device 100 or an image of content received from an external device, and may include a virtual object. Specifically, the image sensor 180 may display the visual information of content stored in the memory 160 or content received from an external device. The virtual object may denote an application or an icon corresponding thereto, content, a user interface for reproducing the content, and the like.

On the other hand, the image output unit 151 may have light transmittance. In this case, the user may view an external environment through the image output unit 151. Furthermore, information on an arbitrary external object constituting an external environment may be displayed on the image output unit 151 while at the same time the external environment is seen. For example, the external object may be a name card, a person or a mutually communicable external device. In other words, the image output unit 151 may display visual information displayed by the controller 180 along with an external environment seen through the image output unit 151 (augmented reality).

On the other hand, the image output unit 151 may be integrally formed with the body 101 or formed with a structure that is detachable by the fastening portion 200.

The camera 121 may be disposed adjacent to at least one of the first and the second image output unit 15a, 151b. Here, the camera 121 may capture a subject seen by a wearer in the same direction as well as may be also disposed at one side or both sides of the body 101 to capture a space other than the wearer's eyesight.

Here, the controller 180 may detect the movement of an external sensed subject and the characteristics of the movement using an image captured on the camera 121.

The user input unit 130 (refer to FIG. 1) may be implemented as an additional touch panel at one side or both sides of the body 101. Alternatively, it may be implemented as a physical key. For example, a power on/of switch may be implemented at one side of the body 101.

For another embodiment, the user input unit 130 may be implemented as an additional external device connected to the body 101. Accordingly, a user may enter a specific command to the additional external device. Otherwise, the image output unit 151 may be implemented as a touch screen to directly receive a control command from the user.

For still another embodiment, the user input unit 130 may be implemented as a module for recognizing a user's voice command. Through this, the user may enter a specific command to the glass-type image display device 100 though his or her voice.

On the other hand, the wireless communication unit 110 may perform wireless communication with a communicable external device. Here, information associated with the external device may be displayed on the image output unit 151.

Here, the controller 180 may transmit and receive wireless signals to and from at least one of input devices and output devices using the wireless communication unit 110. For example, the input device, plurality of output devices and glass-type image display device may be connected using Bluetooth (BT), WiFi in a wireless manner. Otherwise, part of each device may transmit and receive signals in a wired connection manner.

On the other hand, the voice output unit 153a, 153b for outputting voice information corresponding to image information may be formed in a region in contact with a user's ears, namely, at both sides of the body 101. Here, the voice output unit may be formed in a speaker shape covering the ears as illustrated in FIG. 3A or in an earphone shape inserted into the ears as illustrated in FIG. 3B. When the voice output unit is formed in a speaker shape, the voice output unit may be a bone conduction speaker.

On the other hand, referring to FIG. 3, a user may wear the body of the glass-type image display device 100 on part of his or her head. In particular, the image output unit 151 of the glass-type image display device 100 may be disposed toward the user's both eyes. As a result, the user may view a virtual image formed on his or her eyes, and receive a wide screen such as a theater.

Hereinafter, a method of allowing the glass-type image display device 100 having the foregoing constituent elements to execute a different mode according to the wearing location of the body will be described in detail.

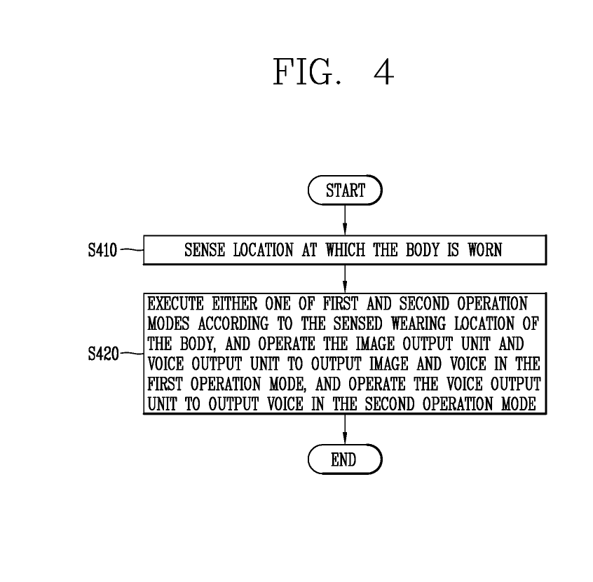

FIG. 4 is a flow chart for explaining a method of controlling a glass-type image display device according to an embodiment of the present disclosure, and FIGS. 5A and 5B are conceptual views for explaining a control method illustrated in FIG. 4.

First, the process (S410) of sensing a location at which the body is worn using the location sensing unit 510 in a state that a glass-type image display device is worn on a user's head may be carried out. For example, the wearing location of the glass-type image display device may include a first wearing location at which an image output unit is located to face the user's both eyes and a second wearing location at which an image output unit is located not to face the user's both eyes.

According to an embodiment, the location sensing unit 510 may be a camera sensor configured to recognize a user's pupils. The location sensing unit 510 is disposed at a location adjacent to the image output unit, and activated to detect the user's pupils when the power of the glass-type image display device is on. As a result of the detection, it is determined that the glass-type image display device is located at the first wearing location when the pupils are detected, and otherwise determined that the glass-type image display device is located at the second wearing location.

On the other hand, the location sensing unit 510 may be provided with a plurality of acceleration sensors or the like as well as the camera sensor to sense the wearing location of the glass-type image display device using a location value measured on the plurality of acceleration sensors.

Next, the process (S420) of executing either one of a first and a second operation mode according to the wearing location of the body sensed by the location sensing unit 510 may be carried out.

For example, as illustrated in FIG. 5A(a), when the image output unit 151 is located to face a user's both eyes, the image output unit and voice output unit may operate to execute a first operation mode for outputting video and voice information. The first operation mode denotes a state for allowing the glass-type image display device to execute the function of a head mounted display (HMD). In other words, when the image output unit 151 faces a user's both eyes, the controller 180 activates the image output unit and voice output unit.

On the contrary, as illustrated in FIG. 5A(b), when the image output unit 151 does not face a user's both eyes, the voice output unit may operate to execute a second operation mode for outputting voice information. The second operation mode denotes a state for allowing the glass-type image display device to execute the function of a headset. Since the user is unable to check an image displayed by the image output unit, the controller 180 automatically deactivates the image output unit, and outputs only voice information.

According to an embodiment, when switched from a first operation mode to a second operation mode, the controller 180 may continuously output voice information has been being outputted. In other words, when the operation mode is changed during the playback of a film, voice information may be continuously outputted without pausing the playback. However, the image output unit may be deactivated to efficiently manage unnecessarily wasted power.

According to another embodiment, the controller 180 may different applications in the first operation mode and the second operation mode, respectively. For example, an application associated with video playback may be executed in the first operation mode, and an application associated with music playback may be executed in the second operation mode. In other words, a user may change the wearing location of a glass-type image display device to execute a different application. As a result, it may be possible to enhance user convenience.

On the other hand, as illustrated in FIG. 5B, a user may wear a glass-type image display device without taking the left and right direction thereof into consideration. In case of voice information, since the left and right side thereof is distinguished from each other, and the user may feel inconvenience. In order to prevent the inconvenience, the controller 180 may control correct voice information to be outputted to the user's left and right ears based on the wearing location sensed by the location sensing unit 510.

As described above, since a user can use a glass-type image display device as a headset during movement, and otherwise use it as a head mounted display, the glass-type image display device may be used in various ways according to the purpose of use, thereby enhancing user convenience.

On the other hand, the image output unit of a glass-type image display device according to an embodiment of the present disclosure may be rotatably coupled to the body. The image output unit may display an image with either one of virtual image optics in which a focus is formed on a user's both eyes according to the rotated state and projection image optics in which a focus is formed on the screen.

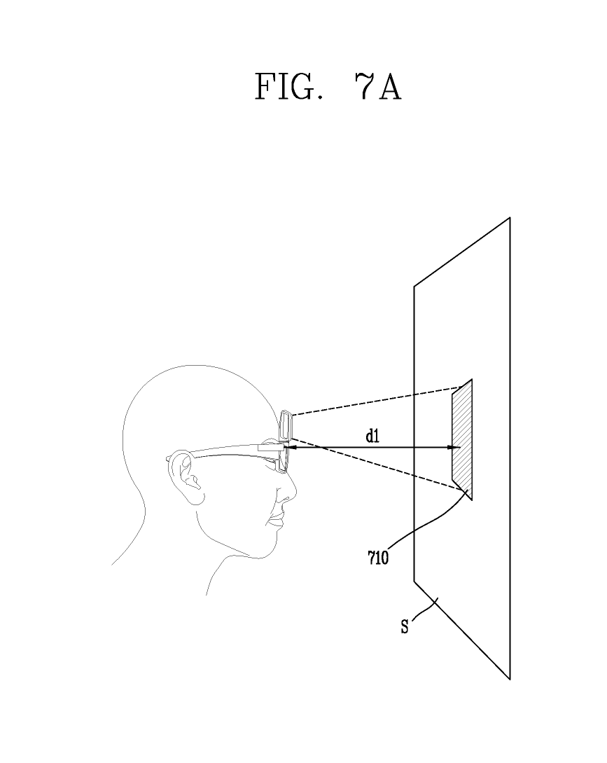

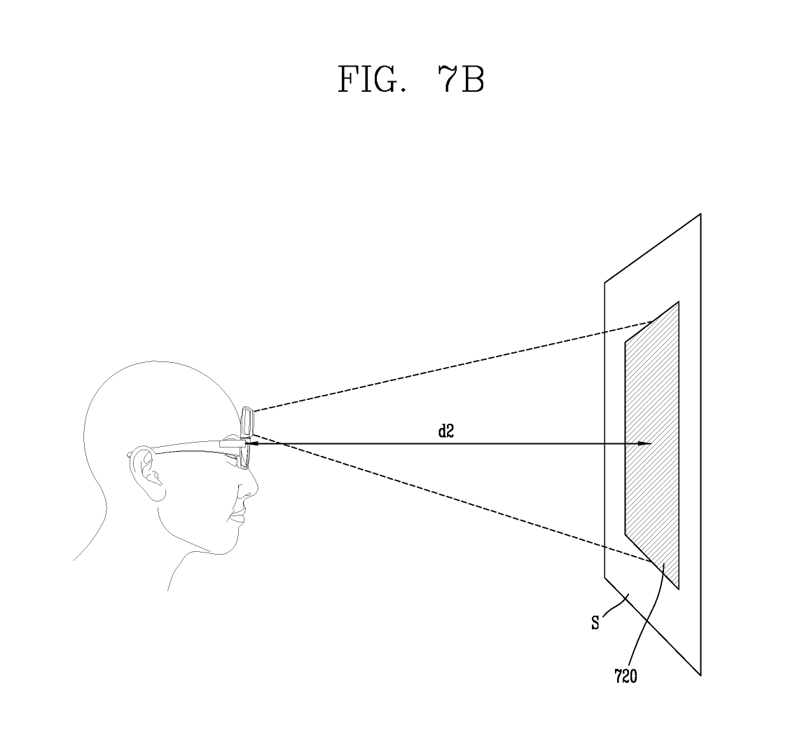

Hereinafter, a glass-type image display device for displaying image information in either one of virtual image optics and projection image optics will be described with reference to FIGS. 6, 7A and 7B.

FIG. 6 is a conceptual view for explaining an embodiment in which an image output unit rotates on a glass-type image display device according to an embodiment of the present disclosure. In FIG. 6, it is illustrated a side view of the glass-type image display device 100 according to an embodiment of the present disclosure. The glass-type image display device 100 may include, a body 101, an image output unit 151, a fastening portion 200 on which the body 101 is coupled to the image output unit 151, and a camera 121.

On the other hand, the image output unit 151 may be rotatably coupled to the body in a first state (refer to FIG. 6A) disposed to cover a front side portion of the body and a second state (refer to FIG. 6C) disposed in parallel to the front side portion. Here, the second state may not be necessarily limited to a case where the image output unit 151 and the front side portion of the body 101 are disposed in parallel, and modified to various angles according to the user's convenience. However, for the sake of convenience of explanation, a state in which the image output unit 151 and the front side portion of the body 101 are disposed in parallel will be set to a second state to describe the characteristics of the present disclosure in detail.

The image output unit 151 is configured to display image information toward both eyes of a user wearing the body 101 in the first state. In other words, a focus is formed to make a virtual image on the user's both eyes, and display image information using virtual image optics. In other words, in a first state, the glass-type image display device 100 performs the function of a head mounted display (HMD).

On the contrary, the image output unit 151 is configured to display an image toward the screen to disposed to be separated from the body 101 in the second state to project an image on the screen. The screen may be a wall or ceiling, for example. The image output unit 151 may form a focus to make an image on the screen other than the user's eyes, and project image information on the screen. In other words, in a second state, the glass-type image display device 100 performs the function of a projector.

On the other hand, the image output unit 151 and the body 101 may be coupled by the fastening portion 200, and the fastening portion 200 may be a hinge, for example. However, the fastening portion 200 may not be necessarily limited to a hinge, and modified to any configuration in which the image output unit 151 is rotatably coupled to an end of the body 101.

On the other hand, the glass-type image display device 100 may include a status sensing unit (not shown) configured to sense whether the image output unit 151 is placed in the first state or the second state. Here, the status sensing unit may be installed on the fastening portion 200. The controller 180 may control the image output unit 151 to display an image having a different focal length in the first state or second state based on the sensing result of the status sensing unit.

On the other hand, the glass-type image display device 100 may further include a luminance sensing unit (not shown) configured to sense ambient brightness on the body 101. The controller 180 may adjust the brightness of an image displayed on the image output unit 151 based on an ambient luminance value acquired by the luminance sensing unit.

On the other hand, the image output unit 151 of the glass-type image display device 100 may include a first and a second image output unit corresponding to a user's left and right eyes.

In the first state, the controller 180 may display images in consideration of binocular disparity to provide a three-dimensional stereoscopic image. In addition, even in the second state, the controller 180 may display different images formed in consideration of binocular disparity on the first and the second image output unit, respectively, thereby projecting a stereoscopic image on the screen.

In addition, the controller 180 may activate either one of the first and the second image output unit, and deactive the other one thereof to project a two-dimensional image on the screen.

FIGS. 7A and 7B are conceptual views for explaining an embodiment in which a glass-type image display device according to an embodiment of the present disclosure is used as a projector. A method of displaying an image in a second state will be described in more detail with reference to FIGS. 7A and 7B.

The glass-type image display device 100 may further include a distance measurement unit (not shown) formed adjacent to the image output unit 151 in the body 101, and configured to measure a distance between the screen (S) and the image output unit 151. For example, the distance measurement unit may be a distance measurement camera, an infrared sensor, a laser sensor, and the like.

The controller 180 may adjust a focal length of an image displayed on the image output unit 151 based on a distance measured by the distance measurement unit. A size of the image displayed on the screen (S) may vary according to the adjustment of a focal length of the image.

As illustrated in FIG. 7A, when the image output unit 151 is disposed in parallel to a front side portion of the body 101 (second state), the controller 180 may display an image 710 toward the screen to display the image on the screen. Here, the distance sensing unit 700 may calculate a straight distance to the screen (S), and the controller 180 may automatically adjust a focal length of the image 710 displayed on the screen (S) based on the calculated distance.

On the other hand, as illustrated in FIG. 7B, the location of the glass-type image display device 100 may be changed according to the movement of a user wearing the glass-type image display device 100. In this case, the controller 180 may readjust a focal length of the image 710 displayed on the screen (S) in real time. Accordingly, the size of an image displayed on the screen (S) may be changed.

Referring to FIGS. 7A and 7B, it is seen that the size of an image 710 or 720 displayed on the screen varies according to a distance (d1 or d2) between the distance measurement unit and the screen (S).

Though not shown in the drawing, since there is a limit to a distance at which a focus can be formed due to the physical characteristics of lenses, a distance measured by the distance measurement unit may not satisfy a predetermined condition. For example, a condition that should be satisfied to display an image on the screen may be set to “2 to 10 m.” The predetermined condition may vary according to the type of the image output unit 151.

On the other hand, the controller 180 may display guide information for guiding the location of the body to move using the output unit 150 when a distance measured by the distance measurement unit does not satisfy a predetermined condition. For example, voice information such as “move forward 2 m toward the screen” may be outputted from the voice output unit 153 or an image for guiding a location to be moved may be displayed on the image output unit 151.

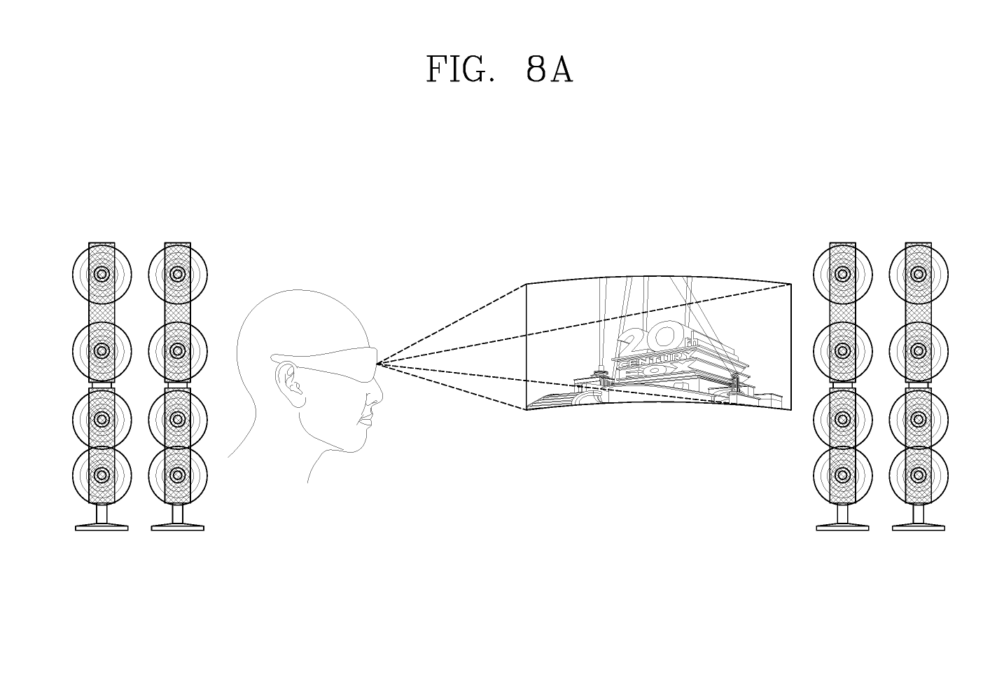

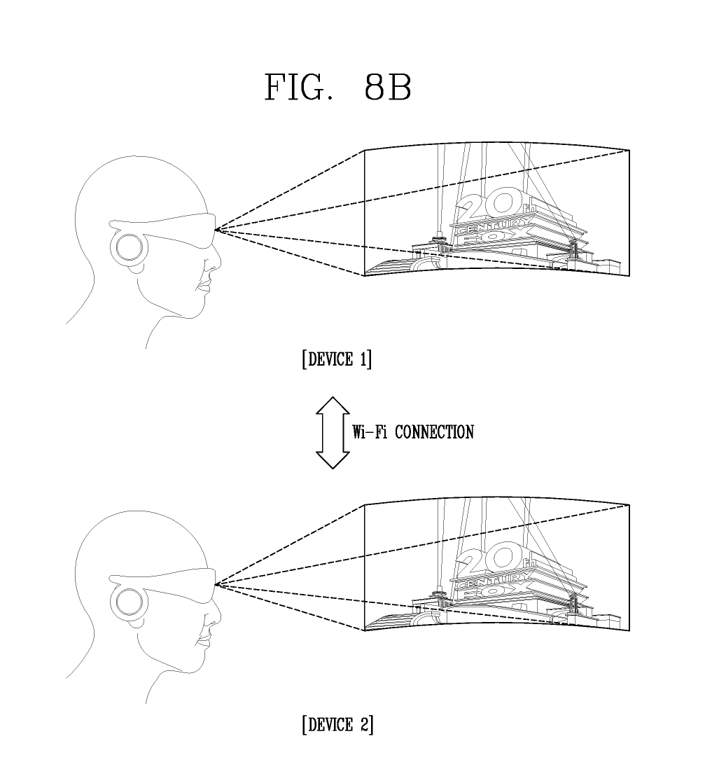

Hereinafter, a method of allowing the glass-type image display device 100 and an external device to be mutually paired and operated will be described in detail. FIGS. 8A and 8B are conceptual views for explaining an embodiment in which a glass-type image display device according to an embodiment of the present disclosure interacts with an external device.

The controller 180 of the glass-type image display device 100 may detect an external device located within a predetermined distance using the wireless communication unit 110, and perform wireless communication with the detected external device.

Here, if the detected external device is able to output at least one of video and voice information, then the controller 180 may transmit a control command to output at least one of the image and voice information outputted on the glass-type image display device 100 to the detected external device based on a user's input.

For example, as illustrated in FIG. 8A, when a home theater speaker is located adjacent to the glass-type image display device 100, the controller 180 may display image information on the image output unit 151, and output voice information to at least one of the voice output unit 153 and the home theater speaker.

The controller 180 may select a device that is to output voice information based on a user input. In addition, when the image output unit 151 is switched to a first state in which the image output unit 151 is disposed to cover a front side portion of the body and a second state in which the image output unit 151 is disposed in parallel to the front side portion, the controller 180 may automatically display image information on the screen, and output voice information to a paired external device.

For another example, as illustrated in FIG. 8B, when another second glass-type image display device (device 2) is located adjacent to a first glass-type image display device (device 1), content being played back may be shared. In other words, content stored in the first glass-type image display device (device 1) may be not only shared, but also image and voice information outputted from the first glass-type image display device (device 1) may be checked in real time on the second glass-type image display device (device 2).

On the other hand, hereinafter, a method of receiving a control command from a user in a glass-type image display device will be described in detail.

Various methods have been proposed as a method of entering a control command to the image display device. Out of conventional methods of physically pressing a button of the image display device to enter a control command, in recent years, a method of entering a control command with a touch input using static electricity flowing through a human body may be mainly used.

However, for wearable devices such as a glass-type image display device, when a control command is entered with a touch input method, a touch input should be applied to the image display device, thereby causing difficulties to the user in a state that it is worn on a human body. In particular, a glass-type image display device has high difficulty in continuously touching a terminal mounted on a user's facial portion.

Accordingly, a terminal provided with an input method capable of overcoming difficulties that can be transferred to the user out of conventional touch methods may be taken into consideration.

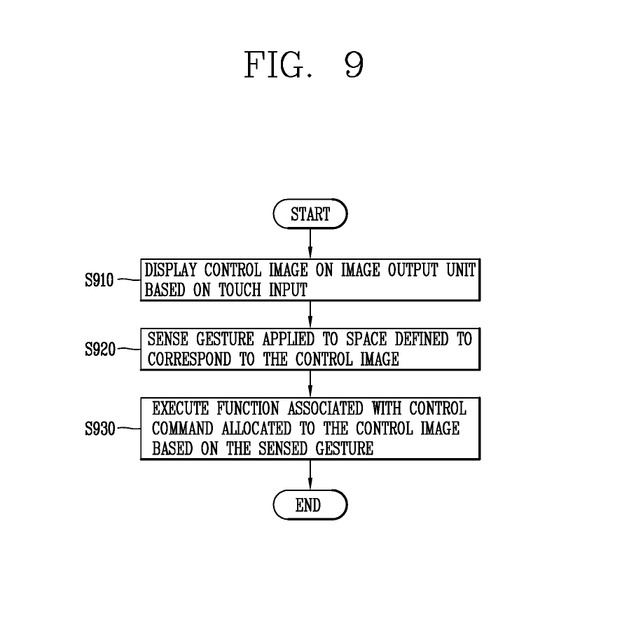

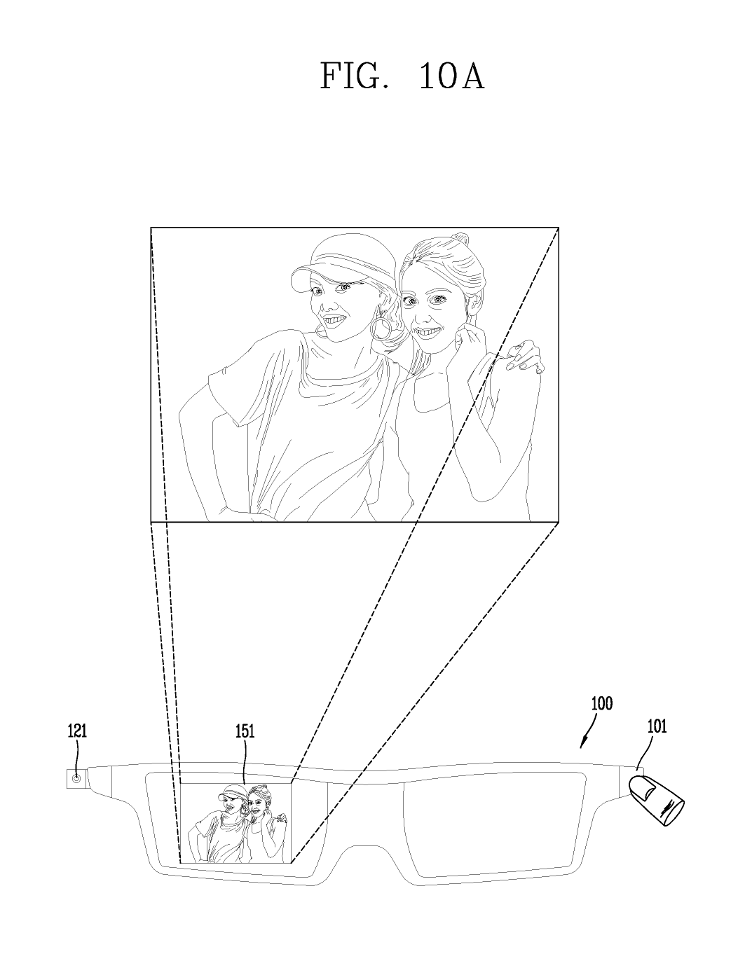

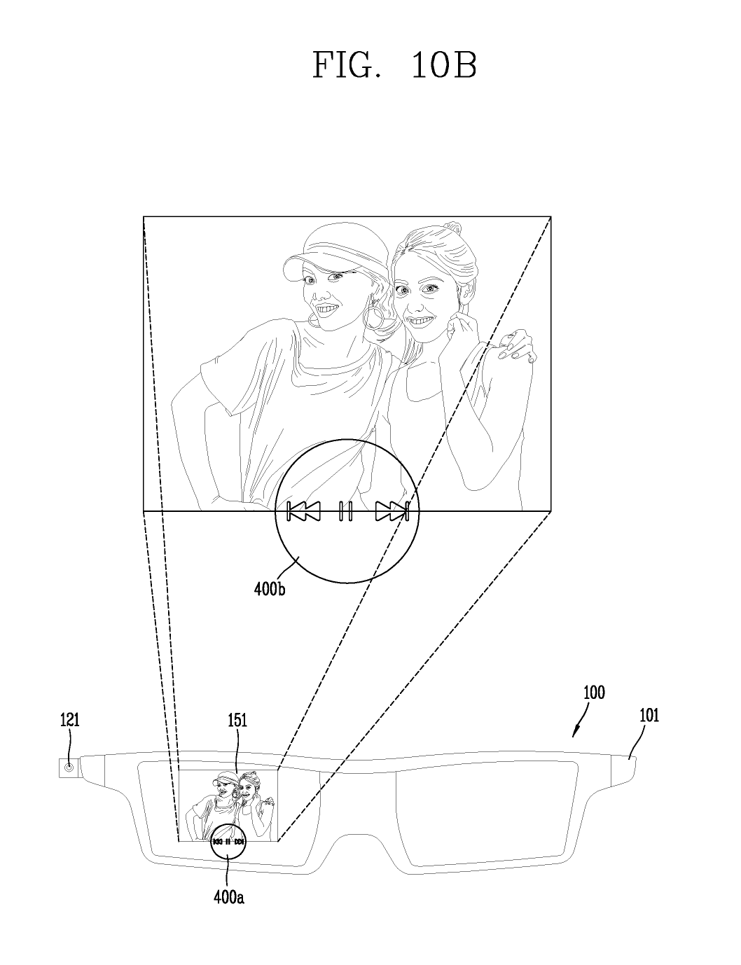

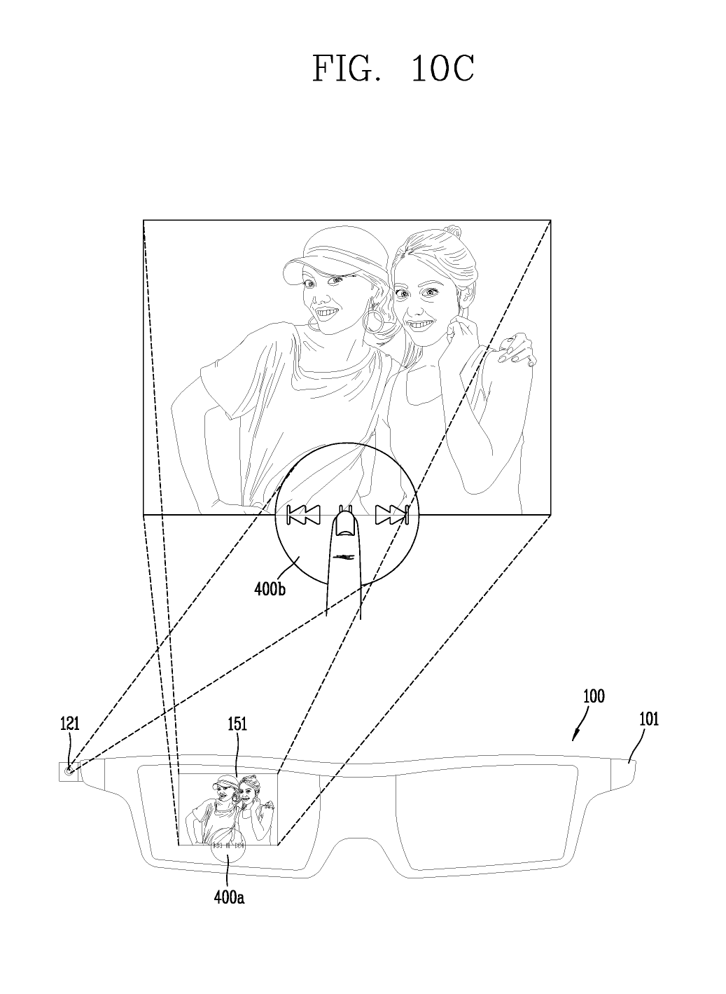

Hereinafter, a control method of entering a control command in a different method from the related art in a glass-type image display device will be described in detail with reference to FIGS. 9, 10A, 10B, and 10C. Meanwhile, it is assumed that the image output unit is formed in a light transmissive manner like a transparent display.

FIG. 9 is a flow chart for explaining a control method of entering a control command in a different method from the related art in a glass-type image display device according to an embodiment of the present disclosure, and FIGS. 10A, 10B and 10C are conceptual views for explaining a control method illustrated in FIG. 9.

First, a control image is displayed on the image output unit 151 (refer to FIG. 2) based on a touch input to implement the present disclosure on a glass-type image display device 100 (S910).

The touch input may be applied through the body 101 (refer to FIG. 2). The body 101 may be formed to be worn on a user's face, and a glasses leg portion of the glass-type image display device 100 may corresponds to the body 101. A touch input unit (not shown) configured to receive a user's touch input may be formed on at least part of the body 101.

The touch input unit receives a user's touch input, and the image output unit 151 displays a control image based on the touch input. The control image displayed on the image output unit 151 may include images associated with control commands required for the glass-type image display device 100. The control image is divided to allow at least one of the plurality of images to be disposed in each region, and different control commands are allocated to each image.

Control commands allocated to a control image may be determined according to image information displayed on the image output unit 151 of the glass-type image display device 100 or voice information outputted from the voice output unit 153 (refer to FIG. 2), and set in advance by the selection of the user. Subsequent to applying a touch input to the body 101 to display a control image, a selector for selecting a control image for displaying the image output unit 151 among a plurality of control images may be first displayed prior to the control image.

Next, a gesture applied to a space defined to correspond to the control image may be sensed (S920).

Since the image output unit 151 of the glass-type image display device 100 is formed in a light transmissive manner, a user may visually recognize an external environment beyond the image output unit 151 through the image output unit 151 as well as image information displayed on the image output unit 151.

The space defined to correspond to the control image may include a space of an external environment recognized beyond the image output unit 151 on a user's line of sight. The image output unit 151 may give perspective to the control image to recognize the control image to be displayed on a space of the external environment on the user's line of sight. Accordingly, the control image displayed on the image output unit 151 is recognized to be displayed in an external environment beyond the image output unit 151 on the user's line of sight.

For example, a gesture may be a behavior of lightly knocking a virtual space defined to correspond to the control image using a subject such as a finger, a fist, a pen or the like.

On the other hand, since a control image displayed on the image output unit 151 is recognized to be displayed in an external environment beyond the image output unit 151 on the user's line of sight, applying a gesture on a space defined to correspond to the control image may allow the user to recognize it as touching the control image in the external environment.

A control image may include a plurality of images allocated to different control commands, and thus when a gesture is applied to the control image like touching an image associated with a control command desired to be applied to the glass-type image display device 100, a gesture applied to a space defined to correspond to the control image corresponds to an input behavior of entering a control command to the glass-type image display device 100.

A space defined to corresponds to the control image is divided into a plurality of spaces, and a different control command to be allocated to each image. The camera 121 may capture an image corresponding to a front side of the body 101, and the controller 180 may sense a gesture applied thereto using the image captured by the camera 121.

When a gesture is applied to a space defined to correspond to the control image, the controller 180 may detect a gesture applied to the space corresponding to which image of a plurality of images allocated to different control commands. A control command to be executed on the glass-type image display device 100 is determined according to a gesture applied to a space corresponding to which image.

Next, a function associated with a control command allocated to the control image may be executed based on the sensed gesture (S930).

Based on the sensed gesture denotes that a space defined to correspond to the control image is determined according to a gesture applied to which one of regions into which a space defined to correspond to the control image is divided.

The control image may include images associated with a plurality of control commands, and the controller 180 (refer to FIG. 3) executes a control command associated with an image displayed in a region to which a user's gesture is applied. A control command executed by the controller may be a control command for directly controlling the glass-type image display device 100, but the present disclosure may not be necessarily limited to this, and also may execute a control command for controlling an external device paired with the glass-type image display device 100 through the wireless communication unit 110 (refer to FIG. 1) of the glass-type image display device 100.

A control command for directly controlling the glass-type image display device 100 may be a control command associated with image information or voice information being outputted from the glass-type image display device 100. For example, the control command may include a control command for pausing or replaying a video (a video being outputted from the image output unit and voice output unit in case of the video including voice information) being displayed on the image output unit 151, a control command for turning a photo displayed in a slide manner on the image output unit 151 over to a next photo or calling a previously shown photo again, a control command for enlarging or reducing image information displayed on the image output unit 151, a control command for increasing or decreasing audio volume outputted from the voice output unit, and the like.

A control command for directly controlling the glass-type image display device 100 may be a control command for executing or pausing content contained in the glass-type image display device 100. For example, when an application is stored in the glass-type image display device 100, a control command for executing the application or suspending the execution of the application may be entered.

Furthermore, when a control image is displayed in a keyboard-like manner out of a simple input, it may be also allowed to have an input in such a manner of inputting text to prepare a document.

When the glass-type image display device 100 is controlled in association with image information displayed on the image output unit 151, image information and voice information may be outputted at the same time on the image output unit 151, thus preventing image information from being visually recognized for the user. Accordingly, a control command for adjusting a region displayed with the control command on the image output unit 151 according to the user's selection or a control command for allowing the displayed control image to cease to exist again may be allocated to the control image. When a region displayed with the control command on the image output unit 151 is adjusted according to the user's selection, a space defined to correspond to the control image is also adjusted in a manner corresponding thereto, and the sensor 121 is also adjusted to sense a gesture applied to a newly adjusted space.

The execution of a control command for controlling an external device may include transmitting signals for controlling the external device to the external device through the wireless communication unit. Hereinafter, it will be described in detail.

In order to control an external device, the glass-type image display device 100 and the external device to be controlled should be paired in advance in a wireless manner prior to the process (S910) of displaying a control image on the image output unit 151 by a touch input.

Furthermore, the control image may vary according to the embodiments. Image information or voice information outputted from an external device may be sensed to display a control image allocated thereto, and the data of image information or voice information currently being outputted is received from an external device to display a control image allocated to a control command associated therewith based on the received data, and a control image previously set by the user's selection may be displayed.

Furthermore, the controller 180 may execute a function associated with a control command allocated to a control image based on a sensed user's gesture (S930), and control the wireless communication unit to transmit signals controlling an external device to the external device through the wireless communication unit. Accordingly, the external device is controlled according to a control signal transmitted from the glass-type image display device 100.

For example, referring to FIG. 8A, a control image for an audio device paired during the playback of a video may be displayed on the image output unit 151. Here, a control command for transmitting and outputting voice information to the audio device may be allocated to the control image. In other words, when a gesture for the control image is applied, voice information that has been outputted from the voice output unit 153 of the glass-type image display device 100 may be outputted from the audio device.

For another example, referring to FIG. 8B, a control image for a second glass-type image display device (device 2) paired while a first glass-type image display device (device 1) plays a video back may be displayed on the image output unit 151. Here, a control command for sharing a video being played back may be allocated to the control image. In other words, when a gesture for the control image is applied, information displayed on the first glass-type image display device (device 1) may be displayed on the second glass-type image display device (device 2).

Hereinafter, an operation implemented on the glass-type image display device 100 according to the present disclosure will be described in detail with reference to FIGS. 10A, 10B and 10C. FIGS. 10A, 10B and 10C are conceptual views for explaining a control method illustrated in FIG. 9.

Referring to FIG. 10A, a video is displayed on the image output unit 151 of the glass-type image display device 100. The image output unit 151 may give perspective to a video to recognize the video to be displayed on an external environment beyond the image output unit 151 with light transmissive characteristics on a user's line of sight. Accordingly, the user may see image information displayed on the image output unit 151 along with the external environment beyond the image output unit 151 at the same time.

A touch input is applied to the body 101 to display a control image for entering a control command to the glass-type image display device 100. The present disclosure is configured to display a control image with a single touch input and enter a subsequent control command through the control image without continuously touching the glass-type image display device 100 to enter a control command to the glass-type image display device 100 contrary to the related art.

Referring to FIG. 10B, a control image 400a is displayed on the image output unit 151 by applying a touch input to the control image 400a. Though the control image 400a is displayed on the image output unit 151, the image output unit 151 gives perspective to the control image 400a to recognize a control image 400b to be displayed in an external environment beyond the image output unit 151 with light transmittance characteristics on a user's line of sight. The control image 400a may be displayed to overlap with a video, and the control image 400b and video to overlap with each other may be recognized in an external environment beyond the image output unit 151 on a user's line of sight.

A control command associated with image information displayed on the image output unit 151 is allocated to the control image 400a, 400b. As illustrated in FIG. 10B, since a video is displayed on the image output unit 151, a control command associated with the playback of a video may be allocated to the control image 400a, 400b.

Referring to FIG. 10C, a user may apply a gesture to a space defined to correspond to the control image 400b to enter a control command without touching the image output unit 151 on which the control image 400a is displayed.

The controller 180 senses a gesture applied to a space defined to correspond to the control image 400b, and divides the space to sense which one of the divided spaces to which the gesture has been applied.

As illustrated in the drawing, an image for pausing a video being played back is displayed at the center of the control image 400a, 400b, and when a user applies a gesture to the center of a space defined to correspond to the control image 400a, 400b, the controller 180 senses a region to which the gesture has been applied.

The controller 180 executes a function associated with a control command allocated to the control image 400a, 400b based on the sensed gesture. In FIG. 5C, a control command for pausing a video being played back has been entered, and thus the controller 180 controls the image output unit 151 and voice output unit 153 to pause the video being displayed.

According to the present disclosure having the foregoing configuration, it may be possible to enter a control command to the glass-type image display device 100 through a gesture applied to a space defined to correspond to a control image, thereby overcoming the difficulties of an input method in the related art in which the glass-type image display device 100 should be continuously touched.

On the other hand, according to an embodiment disclosed in the present disclosure, the foregoing method may be implemented as codes readable by a computer on a medium written by the program. Examples of the computer-readable media may include ROM, RAM, CD-ROM, magnetic tape, floppy disk, and optical data storage device, and the like, and also include a device implemented in the form of a carrier wave (for example, transmission via the Internet).

The foregoing glass-type image display device 100 and a control method thereof will not be applicable in a limited way to the foregoing terminal, and all or part of each embodiment may be selectively combined and configured to make various modifications thereto.

The embodiments of the present disclosure have proposed a scheme capable of controlling a glass-type image display device to be worn on a head, and thus is applicable to various industrial fields.

What is claimed is:

1. A glass-type image display device, comprising:
a body formed to be worn on a user's head;
a location sensing unit formed on the body to sense a location on which the body is worn;
an output unit formed on the body, and provided with an image output unit configured to display image information and a voice output unit configured to output voice information when operated; and
a controller configured to determine at least one operation of the image output unit and the voice output unit according to the wearing location of the body sensed by the location sensing unit.

2. The glass-type image display device of claim 1, wherein the controller executes either one of a first and a second operation mode according to the wearing location of the body, and operates the image and voice output unit in the first operation mode, and operates the voice output unit in the second operation mode.

3. The glass-type image display device of claim 1, wherein the image output unit is rotatably coupled to the body in a first state disposed to cover a front side portion of the body and a second state disposed in parallel to the front side portion.

4. The glass-type image display device of claim 3, wherein the image output unit is configured to display an image having a different focal length in the first state and the second state.

5. The glass-type image display device of claim 4, wherein the image output unit is configured to display an image toward the eyes of a user wearing the body in the first state.

6. The glass-type image display device of claim 4, wherein the image output unit is configured to display an image toward a screen disposed to be separated in the second state to project an image on the screen.

7. The glass-type image display device of claim 6, further comprising:
a distance measurement unit formed adjacent to the image output unit in the body, and configured to measure a distance between the screen and the image output unit,
wherein the controller is configured to adjust a focal length of an image displayed on the image output unit based on a distance measured by the distance measurement unit.

8. The glass-type image display device of claim 7, wherein the controller is configured to display guide information for guiding the location of the body to move using the output unit when the distance measured by the distance measurement unit does not satisfy a predetermined condition.

9. The glass-type image display device of claim 6, wherein the image output unit comprises a first and a second image output unit, and configured to display a two-dimensional or three-dimensional image on the screen using at least one of the first and the second image output unit.

10. The glass-type image display device of claim 4, further comprising:
a status sensing unit configured to sense whether the image output unit is placed in the first state or the second state.

11. The glass-type image display device of claim 10, wherein the status sensing unit is installed on a hinge rotatably coupled to the body.

12. The glass-type image display device of claim 4, further comprising:
a luminance sensing unit configured to sense ambient brightness on the body,
wherein the controller adjusts the brightness of an image displayed on the image output unit based on an ambient luminance value acquired by the luminance sensing unit.

13. The glass-type image display device of claim 1, further comprising:
a wireless communication unit configured to search an external device located within a predetermined distance, and perform communication with the searched external device,
wherein the controller transmits at least one of image information displayed on the image output unit and voice information outputted from the voice output unit to be outputted on the external device.

14. The glass-type image display device of claim 1, wherein the image output unit displays a control image allocated to at least one control command, and further comprises a gesture sensing unit configured to sense a gesture applied to a space defined to correspond to the control image,
wherein the controller executes a function associated with a control command allocated to the control command based on a gestured sensed on the gesture sensing unit.

15. The glass-type image display device of claim 14, wherein the control image comprises a plurality of images associated with different control commands, respectively.

16. The glass-type image display device of claim 15, wherein a space defined to corresponds to the control image is divided into a plural number to allow at least one of the plurality of images to be disposed in each space, and a different control command to be allocated to each image.

17. The glass-type image display device of claim 14, wherein a space defined to corresponds to the control image is a virtual space recognized beyond the image output unit on a user's line of sight, and
the controller gives perspective to the control image to recognize the control image to be displayed on the virtual space.

18. A control method of a glass-type image display device having a body formed to be worn on a user's head, the method comprising:
sensing a location on which the body is worn using a location sensing unit; and
executing either one of a first and a second operation mode according to the wearing location of the body sensed by the location sensing unit, and operating an image output unit and a voice output unit in the first operation mode to output an image and a voice, and operating the voice output unit in the second operation mode to output a voice.

19. The method of claim 18, wherein the image output unit is rotatably coupled to the body in a first state disposed to cover a front side portion of the body and a second state disposed in parallel to the front side portion, and configured to display an image having a different focal length in the first state and the second state.

20. The method of claim 18, further comprising:
displaying a control image on the image output unit in response to a touch input applied to the body;
sensing a gesture applied to a space defined to correspond to the control image; and
executing a function associated with a control command allocated to the control image based on the sensed gesture.
